(19) United States
(12) Patent Application Publication
(10) Pub. No.: US 2025/0319978 A1
(43) Pub. Date: Oct. 16, 2025

(54) POWER CONTROL UNIT FOR AUTOMATICALLY CONTROLLING A DRIVE, AND AIRCRAFT

(71) Applicant: REINER BRACH, OSTERHOLZ-SCHARMBECK (DE)

(72) Inventor: REINER BRACH, OSTERHOLZ-SCHARMBECK (DE)

(21) Appl. No.: 18/869,850

(22) PCT Filed: May 31, 2023
(86) PCT No.: PCT/DE2023/200109

§ 371 Date: Feb. 24, 2025

(30) Foreign Application Priority Data
Jun. 1, 2022 (DE) 10 2022 113 828.3

(51) Int. Cl. B64D 31/09; B64D 27/20; B64D 31/04; G05G 5/03

(52) U.S. Cl. CPC B64D 31/09; B64D 27/20; B64D 31/04; G05G 5/03

(57) ABSTRACT

A power control unit for an aircraft includes a control device and an input device having an adaptive power marker. The aircraft has a first engine which generates a first drive thrust, and a second engine which generates a second drive thrust. A specified power can be input by an operator via the input device. The control device controls the first and the second drive thrust so that the first engine is first controlled at an increasing first drive thrust and, only after reaching a first upper limit thrust, the second drive thrust is also controlled to increase, until a common drive thrust corresponding to the specified power is reached. The adaptive power marker outputs an optical and/or a haptic feedback on an available common drive thrust, an available relevant maximum thrust of the first and/or the second engine, and if a malfunction exists.

### CROSS REFERENCE TO PRIOR APPLICATIONS

This application is a U.S. National Phase application under 35 U.S.C. § 371 of International Application No. PCT/DE2023/200109, filed on May 31, 2023 and which claims benefit to German Patent Application No. 10 2022 113 828.3, filed on Jun. 1, 2022. The International Application was published in German on Dec. 7, 2023 as WO 2023/232205 A1 under PCT Article 21(2).

### FIELD

The present invention relates to a power control unit for automatically controlling a drive of an aircraft which is in a normal operating state, the power control unit comprising a control device and an input device, wherein the aircraft is configured to fly in ambient air via dynamic lift for overcoming a service weight, comprises a first engine, which is configured to generate a first drive thrust and has a first idle thrust and a first maximum thrust, and at least one second engine, which is configured to generate a second drive thrust and has a second idle thrust and a second maximum thrust, and can be accelerated relative to the ambient air via each drive thrust, and wherein a specified power can be input by an operator via the input device.

### BACKGROUND

Known power control units, which are constructed in the form of a thrust lever comprising associated control electronics comprise, for example, two thrust levers which are arranged in parallel with one another, each of which is a thrust lever for each engine, for controlling, for example, different engines. In normal flight operation, both engines are in this case usually each controlled in parallel with one another so that, for example, the same drive thrust is output by both engines in order to reach a total drive thrust.

Both engines are in this case evenly loaded, however, this often also involves even, frequently time-dependent, wear to both engines. Both engines are also operated for a long period of time in the range of a partial power output. This results in efficiency drawbacks.

Systems are also known which allow for a safe operation of a multi-engine aircraft in the event of an engine failure. US 2020/0362753 A1 here describes controlling two engines of a helicopter so that one engine is kept in a standby mode and its power is increased when another engine is indicating a power loss. A specific control unit is here not, however, described.

U.S. Pat. No. 6,880,784 B1 describes automatically controlling a take-off thrust for a supersonic airplane to reduce noise. Engine power is here reduced for individual flight phases.

US 2005/0178890 A1 describes using the thrust of different engines in different power classes in an aircraft in an uneven manner.

US 2014/0117148 A1 describes a method for controlling engines and for handling an engine failure in a hybrid helicopter. Power losses are in this case absorbed via another drive system using different drive technologies.

US 2020/0277064 A1 discloses controlling a hybrid aircraft.

US 2021/0323425 A1 describes a charging system for electrical drive units of an aircraft and assisting a main engine with an electrical drive.

U.S. Pat. No. 5,855,340 A describes a corporate jet comprising two engines, wherein the two engines have different powers.

U.S. Pat. No. 4,456,204 describes an airplane comprising an intake opening arranged in the rudder unit for a third engine arranged in the rear fuselage.

EP 4 059 837 A1 describes a hybrid drive system for a helicopter. A system made up of a combustion engine and an electrical drive is in this case controlled via a control device.

“Wikipedia: Hawker Siddeley Trident” also describes the use of an additional engine for a time-limited power increase in order to shorten a take-off distance of a commercial jet.

### SUMMARY

An aspect of the present invention is to improve upon the prior art.

In an embodiment, the present invention provides a power control unit for automatically controlling a drive of an aircraft which is in a normal operating state. The power control unit includes a control device and an input device which comprises at least one adaptive power marker. The aircraft is configured to fly in ambient air via a dynamic lift for overcoming a service weight. The aircraft comprises a first engine which is configured to generate a first drive thrust which comprises a first idle thrust and a first maximum thrust, and at least one second engine which is configured to generate a second drive thrust which comprises a second idle thrust and a second maximum thrust. Each of the first engine, via the first drive thrust, and the at least one second engine, via the second drive thrust, can be accelerated relative to the ambient air. A specified power can be input by an operator via the input device. The control device is configured so that, in the normal operating state, the first drive thrust and the second drive thrust are controlled relative to one another depending on the specified power at an increasing specified power so that the first engine is first controlled at an increasing first drive thrust and, only after a first upper limit thrust of the first engine has been reached, the second drive thrust is also additionally controlled so as to increase, until a common drive thrust corresponding to the specified power is reached. Each of the at least one adaptive power marker is configured to output at least one of an optical feedback and a haptic feedback on at least one of, an available common drive thrust, an available relevant maximum thrust of at least one of the first engine and the second engine, and if a malfunction exists.

### BRIEF DESCRIPTION OF THE DRAWINGS

The present invention is described in greater detail below on the basis of embodiments and of the drawings in which:

FIG. 1 is a schematic side view of a corporate jet;

FIG. 2 is a schematic view of a thrust control panel for a corporate jet in FIG. 1;

FIG. 3 is a schematic view of an alternative thrust control panel for the corporate jet in FIG. 1; and

FIG. 4 is a graph showing thrust functions of various engines of the corporate jet in FIG. 1.

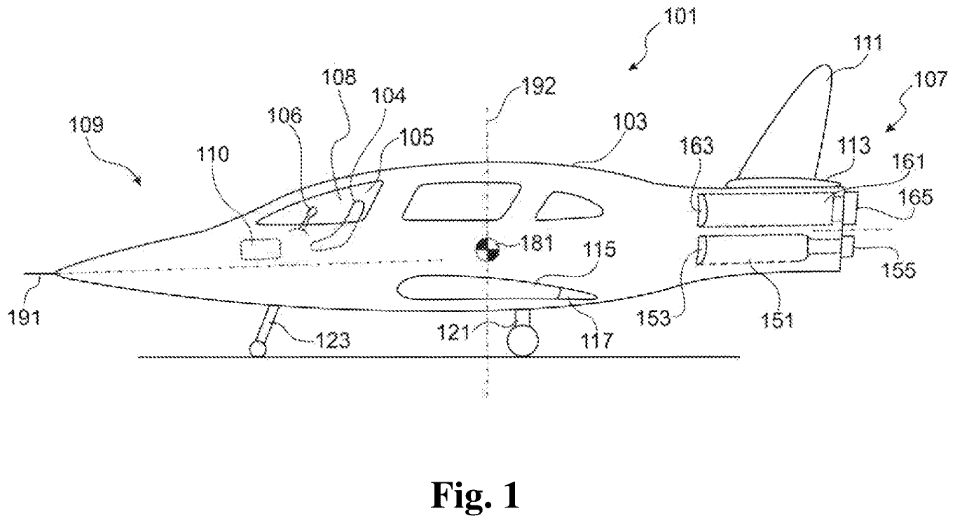

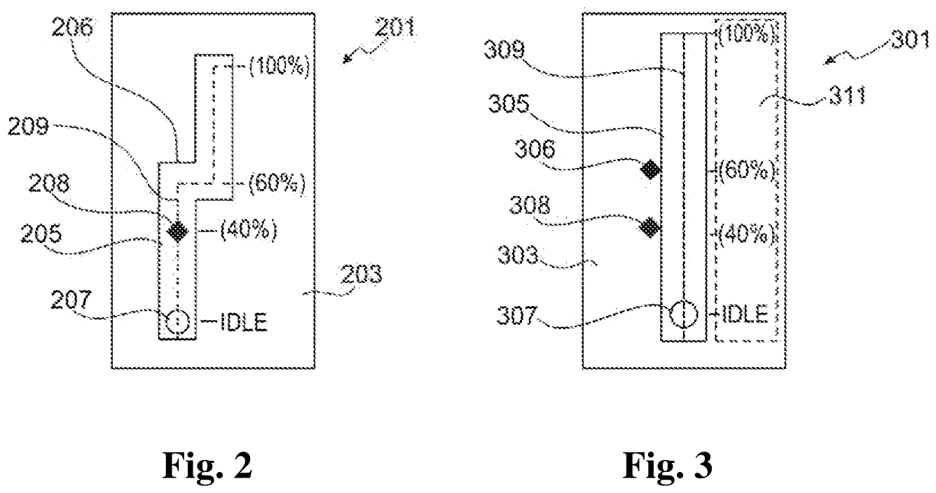

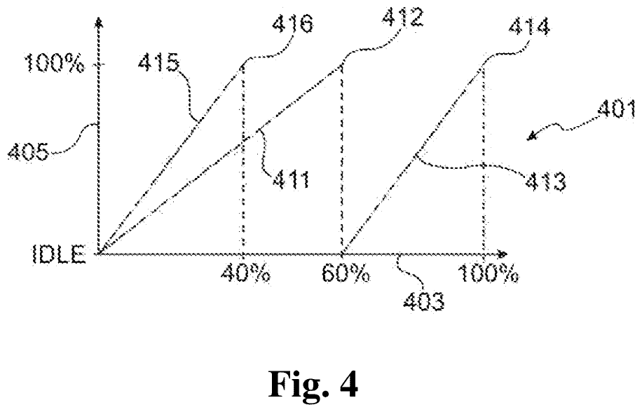

### DETAILED DESCRIPTION

The present invention provides a power control unit for automatically controlling a drive of an aircraft which is in a normal operating state, the power control unit comprising a control device and an input device, wherein the aircraft is configured to fly in ambient air via dynamic lift for overcoming a service weight, comprises a first engine, which is configured to generate a first drive thrust and has a first idle thrust and a first maximum thrust, and at least one second engine, which is configured to generate a second drive thrust and has a second idle thrust and a second maximum thrust, and can be accelerated relative to the ambient air via each drive thrust, and wherein a specified power can be input by an operator via the input device, wherein the control device is configured so that, in a normal operating state, the first drive thrust and the second drive thrust are controlled relative to one another via the control device depending on the specified power at an increasing specified power so that, first, the first engine is controlled at an increasing first drive thrust and, only after a first upper limit thrust of the first engine has been reached, the second drive thrust is controlled so as to increase, in each case until a common drive thrust corresponding to the specified power is reached. The input device in this case comprises at least one adaptive power marker, wherein the adaptive power marker or each adaptive power marker is configured to output optical and/or haptic feedback on an available common drive thrust, an available relevant maximum thrust of the relevant engine and/or to output optical and/or haptic feedback on the presence of a malfunction.

The core concept of the present invention is in this case to first utilize the respectively available increasing first drive thrust of the first engine until the first upper limit thrust is reached, and only then to use the drive thrust of the second engine in an increasing manner, starting, for example, from an idle power. For example, when using a partial drive thrust, as is required, for example, for cruising flight, the second engine is therefore only operated in idle mode, meaning that, for example, wear monitoring based on the load does not register any maintenance-related wear. The second engine is therefore protected in certain operating states. According to the invention, it is also possible that, for example, if the first engine fails, the second engine is already being operated at idle power and is therefore available to provide drive thrust. In order to give an operator, in particular a pilot of the aircraft, corresponding feedback on available drive thrusts, the adaptive power marker is provided and can in particular adaptively give feedback on the state of the drive system.

The following terms are explained in this context:

A “power control unit” is, for example, a control computer, an arithmetic logic device, or another electronic device for controlling power of a drive. In a simple form, a power control unit of this kind can also be mechanically implemented, wherein electronic systems, also called FADECs, are in particular used.

“Automatically controlling” in this case describes that on the basis of an input power, which is specified, for example, by a pilot, the corresponding parameters of a corresponding engine are controlled automatically, namely, via the power control unit, so that the operator's specifications are taken into account.

The power control unit in this case comprises a “control device”, i.e., an arithmetic logic device which processes corresponding input signals and output signals, and an “input device”, i.e., a device for an operator to, for example, input a specified power. In a simple configuration, the control device can here, for example, be in the form of a mechanical controller, however, the control device is usually configured electronically and is therefore configured to also receive other signals, for example, from an autopilot system, and can process them within the power control unit in relation to the required drive thrust. The control device can here also comprise different sub-systems, for example, each for controlling an individual engine, wherein a specified value for the desired power of the relevant engine is then relayed to the relevant sub-system via a superordinate system. The control device is in this case in particular configured to independently control technical parameters required for a malfunction-free operation of a relevant engine. The input device is here, for example, a mechanical input device which can be operated by an operator or, as mentioned above, is an autopilot or a so-called auto-throttle system for specifying a desired engine power and/or a desired drive thrust.

An “aircraft” in this case in particular describes an airplane which develops dynamic lift by a forward movement and can therefore overcome its service weight. The aircraft can, however, also be a rotary-wing aircraft, for example, a helicopter, which is in particular driven by a plurality of engines.

A “normal operating state” of an aircraft in this case describes the state in which, for example, the engines provided for the flight are ready to operate and are undamaged and the aircraft can accordingly be used as usually intended without emergency measures or fallback measures having to be taken.

An aircraft of this kind is driven via a “drive thrust”, i.e., for example, via mass flows ejected counter to a flight direction, as are generated, for example, by a jet engine. For this purpose, the aircraft comprises a relevant “engine”, wherein the term “engine” in particular denotes all of the required components and devices which are necessary for generating the drive thrust. The relevant engine thus comprises, for example, a thermal engine, an electric motor, or another mechanical power source, which then generates the drive thrust via additional components, for example, a propeller, turbine blades, or the like. An engine of this kind is characterized by “idle thrust”, i.e., thrust output in the idle mode of the engine, for example, and a relevant “maximum thrust”, i.e., the thrust that can be output at a maximum by the relevant engine for technical reasons. The corresponding characteristic values can here, for example, be determined in a so-called standard atmosphere or also for certain flight states, certain altitudes, or the like. The core concept here is to characterize the minimum available capacity of each engine and the maximum available capacity of each engine.

The aircraft can then be accelerated relative to the ambient air via the relevant drive thrust or a total of drive thrust of the respective engines, which makes flight possible. A “specified power” is in this case input via the input device, wherein this specified power is a representation of the power required by an operator, for example, a pilot or an autopilot, for the relevant flight condition. The specified power for take-off is, for example, set to 100% of the available power, while in cruising flight, for example, only 35% of the corresponding drive thrust is required in order to move an aerodynamically accordingly configured aircraft having retracted lift aids and retracted landing gear, for example, in a stationary straight flight.

The present invention provides that the respective drive thrusts are controlled “relative to one another” “depending on the specified power”. This describes that respective engines are controlled depending on the specified power independently of one another, but with the aim of generating a common, in particular an added-up, drive thrust according to the above description.

An “upper limit thrust” in this case describes a capacity of the relevant engine that is available according to the flight condition to which the engine in question is first controlled with increasing power before the other engine is controlled out of idle thrust towards its maximum thrust. The limit thrust can here also be a limit for a maximum available drive thrust for the relevant engine that is set, for example, by maintenance specifications, a wear assessment, or a desired fuel saving.

An “adaptive power marker” is in this case, for example, an adaptive luminous bar arranged on the input device, a corresponding power latch for a thrust lever, or a similarly acting technical device, for example, in order to be able to provide an operator optical and/or haptic feedback. Haptic feedback can, for example, also consist in that, for example, a thrust lever is limited in its movement by the adaptive power marker when the maximum drive power expected in the normal operating state in the form of a common maximum drive thrust is not available.

In order to be able to accordingly control the engines even with a reduced power demand, the control device is configured so that, in the normal operating state, the first drive thrust and the second drive thrust are controlled relative to one another depending on the specified power at a decreasing specified power so that, first, the second engine is controlled at a decreasing second drive thrust and, only after a second lower limit thrust of the second engine has been reached, the first drive thrust is controlled so as to decrease, in each case until a common drive thrust corresponding to the specified power is reached.

The relevant “lower limit thrust” in this context is, for example, defined by a minimum available thrust of the second engine or by a minimum available thrust set by maintenance specifications, operating specifications, or the like. A lower limit thrust can in this case, for example, also be above an idle thrust of the second engine if, for example, a power reduction in the engine that is too rapid or too great would result in failure of the engine or in operational malfunctions in given flow states.

In an embodiment of the present invention, the first upper limit thrust can, for example, be equal to the first maximum thrust or an upper limit thrust of the first engine that is safe for the relevant operating state. The second lower limit thrust can likewise correspond to the second idle thrust.

An “upper limit thrust that is safe for a relevant operating state” is, for example, a maximum upper limit thrust that is available owing to air density, temperature and/or weather conditions and is, for example, below the available maximum thrust or the nominal maximum thrust of the engine. A safe upper limit thrust of this kind is also defined in that, for example, a corresponding engine-protecting maximum power of, for example, only 95% of the maximum thrust results when calculating flight parameters for a take-off run on the basis of an available runway distance.

In order to also provide for a safe flight operation outside of a normal operating state via the power control unit, when a malfunction occurs on the first engine or on the second engine, which is identified via a malfunction sensor, the control device switches into a malfunction operating state, wherein, in the malfunction operating state, the relevant drive thrust of the non-malfunctioning engine is controlled until a common drive thrust corresponding to the specified power is reached or until there is an available drive thrust corresponding to a relevant maximum thrust of the non-malfunctioning engine.

A “malfunction” in this case describes, for example, any predictable or even unpredictable influencing variable for the operational safety of a relevant engine so that, for example, an engine failure due to a bird strike, an engine failure due to damage from a fire in the engine, a reduction in the engine power due to temperature problems, or the like can be defined. A malfunction of this kind is ascertained via a “malfunction sensor”, i.e., for example, via a vibration sensor, a temperature sensor, a flame sensor, or also, for example, via a complex evaluation of available operating parameters of a relevant engine.

“Switching” into a malfunction operating state in this case describes a behavior of the control device which is, for example, implemented via corresponding software, by the control device acting according to the then selected malfunction operating state, i.e., in particular differently from the normal operating state.

In an embodiment of the present invention, the core concept is that a non-malfunctioning engine which can, for example, still provide the relevant maximum thrust is then automatically actuated via the power control unit so that the relevant maximum thrust is provided when required and when the malfunctioning engine can no longer provide sufficient thrust. This state can also then be displayed optically and/or haptically by a correspondingly arranged adaptive power marker. This can be provided, for example, by a movement path of the input device being limited to a path corresponding to the temporarily available maximum thrust, in particular in a haptically perceptible manner.

In an embodiment of the present invention, a display device can, for example, be assigned to the input device, wherein information relating to a relevant operating state, information relating to an available maximum drive thrust, and/or information regarding an identified malfunction, can be displayed via the display device.

So-called “situation awareness”, which is expanded compared with the feedback from the adaptive power marker, can, for example, be provided for a pilot, for example, via the display device, for example, via the display device displaying which of the respective engines is available, which operating state is selected, whether there are malfunctions of one or more engines, and which operating state, namely, the normal operating state or the malfunction operating state, is currently selected and available.

A “display device” in this case is, for example, any device that is suitable for making corresponding information accessible to an operator. In a simple configuration, the display device can comprise a lamp or a warning light; a display via a text output, an image output or another warning output on a display or screen is likewise possible.

In an embodiment of the present invention, the input device can, for example, be a thrust lever unit, wherein the thrust lever unit in particular comprises a brake device for adaptively hampering a movement of a thrust lever of the thrust lever unit, wherein in particular the adaptive power marker is produced via the brake device, in particular in a haptically perceptible manner.

In this case, a “thrust lever unit” of this kind corresponds, for example, to a standard configuration of a corresponding control panel in an aircraft in which a “thrust lever”, i.e., for example, a lever or knob that is movable about an axis of rotation or can be shifted along a path, is arranged, the position of which corresponds to a specified power. A “brake device” in this case is, for example, a slip clutch which accordingly brakes or hampers a movement of the thrust lever so that the adaptive power marker is implemented. On the basis of movement of the thrust lever in the thrust lever unit being hampered, the operator can therefore recognize that, for example, the adaptive power marker has been reached and thus a maximum available drive thrust has also been reached. It should be noted in this context that in particular a single thrust lever in conjunction with the adaptive power marker makes it possible to control two engines or a plurality of engines since the operating state of the respective engines and/or, for example, an available maximum thrust is apparent or haptically perceptible even at one single thrust lever.

The present invention also provides a drive system comprising a power control unit according to any of the previously described embodiments, a first engine, and at least one second engine.

In particular when providing a drive system consisting of at least one power control unit and corresponding engines, an integral solution for the safe, economical, and maintenance-friendly operation of a corresponding aircraft can be provided, wherein an operator is informed of the state of the engines and/or, for example, available maximum thrust in each flight condition at all times.

In an embodiment of the present invention, the drive system can, for example, be configured so that the first maximum thrust of the first engine is at most 90%, 80%, 70%, 65%, 55%, 50%, in particular 45%, of the second maximum thrust or the second maximum thrust is at most 90%, 80%, 70%, 65%, 55%, 50%, in particular 45%, of the first maximum thrust.

Via this configuration, in which a first engine or a second engine can each provide a different maximum power, i.e., a differing maximum thrust from the other engine, the more powerful engine can, for example, first be utilized at full capacity for a take-off process of the aircraft before the less powerful engine is used. It is likewise possible to first fully utilize the less powerful engine and to provide sufficient thrust for stationary cruising flight using this less powerful engine in a cruising flight condition of the aircraft, for example, wherein the less powerful engine is then operated in an idle mode, meaning that maintenance-related operating hours are not, for example, accrued. It is likewise possible in this context to switch the control device from the take-off condition into the cruising flight condition, for example, depending on respective flight parameters.

The drive system can likewise comprise further engines, which are each then assigned to the first engine or the second engine so that, for example, a first group of engines and a second group of engines can be controlled analogously to the first engine and the second engine.

The present invention also provides an aircraft comprising a power control unit according to any of the previously described embodiments and/or comprising a drive system according to the previously described embodiments.

An aircraft of this kind can be particularly advantageously operated when the first engine and the second engine are, for example, arranged in the region of a central plane of the aircraft so that only low yaw moments about a vertical axis of the aircraft arise in the event of engine failure since, for example, a corresponding difference in thrust of the respective engines also does not bring about any relevant yaw moments in normal operation, and taking the above-described control logic into account. An operator is in this case always aware of which operating state the respective engines are in and what maximum thrust is available for each.

The present invention will be explained in greater detail below on the basis of exemplary embodiments as described in the drawings.

A corporate jet 101 comprises a fuselage structure 103. The fuselage structure 103 acts as part of the structural frame of the corporate jet 101 and comprises windowpanes 105, which act as a cockpit windowpane for a cockpit 108. A thrust control panel 106, which is used by a pilot to specify a desired thrust, is arranged within the cockpit 108. A FADEC system 110, which comprises a digital, fully automatic engine controller (which is only shown by way of example) is used to control the thrust. The corporate jet 101 is depicted as a low-wing plane comprising a conventional tail unit in a standard configuration with a rudder unit 111, a horizontal tail unit 113, and a wing 115. The rudder unit 111 and the horizontal tail unit 113 are arranged on the tail 107.

The wing 115 comprises lift aids 117, i.e., landing flaps, for example, for increasing the lift in certain flight situations, such as take-off and landing. The corporate jet 101 also comprises a main landing gear 121 and a nose landing gear 123, each of which are retractable.

Two engines, namely, an engine 151 comprising an air intake 153 and a nozzle 155 and an engine 161 comprising an air intake 163 and a nozzle 165, are arranged in the tail 107. The engines 151 and 161 are bypass turbine engines which operate in accordance with the principle of a gas turbine having an additional bypass fan (which is not shown in detail). For this purpose, the engines draw in air through the corresponding air intakes 153 and 163, increase the energy contained in the air by combustion in a respective combustion chamber (which is not shown), and eject corresponding hot and accelerated exhaust gases together with the accelerated air masses from the respective bypass fan through the respective nozzles 155 and 165, so that thrust is produced for the corporate jet 101 and can accelerate it. In a fully loaded take-off configuration, the corporate jet 101 weighs approximately 5,000 kg, which corresponds to a weight force of approximately 49,000 N. The engine 151 has a maximum thrust of approximately 1,5000 N, whereas the engine 161 has a maximum thrust of 2,5000 N.

The engine 151 is therefore configured, with its maximum thrust, to be able to safely and efficiently operate the corporate jet 101, in particular during cruising flight, whereas the engine 161, with its considerably greater thrust, can be used to provide sufficient capacity of the corporate jet 101 under hot-and-high conditions and/or when particularly short take-off and landing distances are, for example, sought. The maximum thrust of the engine 151 is in this case selected so that the power required for the total weight of the aircraft for an aborted take-off, which is no longer possible, is authorized to be available in line with a so-called decision-making ability in order to provide a safe ascent of the corporate jet 101. The capacity of the engine 151 can likewise be used, for example, only when enough runway is available for a long take-off run. The engine 161 that is then in idle mode can then remain in idle mode without affecting maintenance-related operating hours. Corresponding amounts of fuel can also be saved. The engines are controlled by the FADEC system 110, i.e., an autonomous, fully digital, electronic controller, for the two engines 151 and 161 on the basis of pilot inputs into the thrust control panel 106 in the cockpit 108.

The corporate jet 101 has a center of gravity 181, which in the present case is used as an example of a center of mass in the loaded and occupied state. When viewed in the longitudinal direction along a longitudinal axis 191, the engine 151 is in this case arranged slightly below the center of gravity 181 and the engine 161 is arranged above the center of gravity 181. When viewed in a plan view (which is not shown), both engines 151 and 161 are arranged symmetrically along a central plane of the corporate jet 101 so that no yaw moment exists about a vertical axis 192 when there is different thrust of the engines 151 and 161.

A thrust control panel 201 shows an exemplary configuration of a thrust control panel, as the thrust control panel 106 can, for example, also be configured. The thrust control panel 201 comprises a front panel 203 which is mounted within the cockpit of the corporate jet 101 so that it can be operated by the pilot. A slot-shaped shift gate 205, in which a single thrust lever 207 can be moved, is provided in the front panel 203. The thrust lever 207 is in this case movable along a path 209, wherein the path 209 undergoes a direction shift 206 via the shape of the shift gate 205. The thrust lever 207 is in this case moved starting from an idle position up to the direction shift 206, at which approximately 60% of a total available drive power for the corporate jet 101 is available. After shifting the direction of the thrust lever 207 along the path 209, i.e., a noticeable interruption in a straight-line movement of the thrust lever 207, the thrust lever can then be moved further up to 100% engine power.

The drive power applied at the direction shift 206 in normal operation of approximately 60% corresponds to the maximum power of the more powerful engine 161, wherein the difference between the 60% drive power and the maximum available 100% drive power corresponds to the capacity of the engine 151, which is reduced compared to that of the more powerful engine 161.

A block 208 (which is indicated by way of example) is also provided at approximately 40% engine power which can brake a movement of the thrust lever 207 at this point. A perceptible block 208 is therefore provided to the pilot when he/she increases the required power via the thrust lever 207, which block 208 is then activated and is felt if, for example, the more powerful engine 161 malfunctions and is only still providing the drive power of the less powerful engine 151. The engine 161 is monitored for this purpose and a malfunction thereof is transmitted to the controller of the thrust control panel 201 so that the block 208 can be activated, for example, via a brake, and the pilot is provided with direct haptic feedback on the available thrust. The direction shift 206 can furthermore, for example, be temporarily blocked in order to indicate to the pilot the lack of availability, in particular also in addition to an error message on a display in the cockpit.

The corresponding power markers (“idle”, “40%”, “60%” and “100%”) are printed on the front panel 203 and can be marked via a backlight (which is not shown) so that, in normal operation, the power markers “idle”, “60%” and “100%” are visible, for example, while, when an engine 161 is malfunctioning, the marker “40%” is backlit, for example, in the color red, in order to indicate a malfunction and an altered operating state, which is also called a malfunction operating state.

An alternative thrust control panel 301 is analogously provided with a front panel 303, wherein a thrust lever 307 is guided in a shift gate 305. The shift gate 305 is straight in this case so that the thrust lever 307 can be moved along a straight path 309 between an idle power and a maximum power. Analogous to the above example, a latch 306 is provided at 40% total available power, wherein, unlike the direction shift 206, which is mechanically made in the front panel 203, a further latch 308 is provided in the thrust control panel 301. The latches 306 and 308 are constructed as a brake for the thrust lever 307 analogous to block 208. The function of the differently available engine powers is analogous to the above example. A display 311 is furthermore provided in the front panel 303 via which a display of the markers (“idle”, “40%”, “60%” and “100%”) and the respectively available powers is shown, analogous to the above example. A power range of, for example, between 40% and 100% that is no longer available when the malfunction operating state is reached can therefore be shaded in red in the background so that a pilot also receives optical feedback on the available power of the respective engines or an overall available drive thrust power in addition to the then activated latch 306, which is implemented, for example, via an electrical brake, and therefore in addition to the haptic feedback.

A graph 401 shows an X axis 403 and a Y axis 405. The graph 401 is used to show the different powers of the engines in different operating states. The X axis 403 here shows the drive thrust power required via the thrust lever 207 or 307, i.e., the specified power. On the Y axis 405, the relevant power of the relevant engine is shown between idle power and 100% available power. In a normal operating state, when the power is increasing, as specified via the thrust lever 207 or 307, the more powerful engine 161 is first actuated according to the thrust function 411 up to a maximum thrust 412, via which 60% of the total available drive power of the corporate jet 101 is then available. If the thrust lever is then moved further, i.e., beyond the 60% marker, the engine 151 is also actuated according to the thrust function 413 with increasing thrust up to a maximum thrust 414, wherein engine 161 remains at the maximum thrust 412 in the process. Conversely, i.e., when the thrust lever 207 or 307 is moved back towards an idle power, the power of engine 151 is first reduced until idle power is reached, and only then is engine 161 controlled from the maximum thrust 412 towards an idle power.

If engine 161 is, for example, malfunctioning, has failed due to a fire or damage, or is otherwise not available, the thrust lever 207 or 307 is moved from the idle position towards a higher power, wherein the latches 306 or 308 mark the maximum available power and make it perceptible to the pilot. The backlit “40%” display in the front panel 203 or, alternatively, the “40%” marker that is shown on the display 311 and is, for example, highlighted, indicates that a maximum available power has thus been reached. In this operating state, engine 151 is then controlled according to the thrust function 415 from idle power up to a maximum thrust 416, via which 40% of the total available drive power of the corporate jet 101 is reached, for example, to allow for a safe return to an airport.

The present invention is not limited to embodiments described herein; reference should be had to the appended claims.

### LIST OF REFERENCE NUMERALS

101 Corporate jet
103 Fuselage structure
104 Seat
105 Windowpane
106 Thrust control panel
107 Tail
108 Cockpit
109 Nose
110 FADEC system
111 Rudder unit
113 Horizontal tail unit
115 Wing
117 Lift aids
121 Main landing gear
123 Nose landing gear
151 Engine
153 Air intake
155 Nozzle
161 Engine
163 Air intake
165 Nozzle
181 Center of gravity
191 Longitudinal axis
192 Vertical axis
201 Thrust control panel
203 Front panel
205 Shift gate
206 Direction shift
207 Thrust lever
208 Block
209 Path
301 Thrust control panel
303 Front panel
305 Shift gate
306 Latch
307 Thrust lever
308 Latch
309 Path
311 Display
401 Graph
403 X axis
405 Y axis
411 Thrust function
412 Maximum thrust
413 Thrust function
414 Maximum thrust
415 Thrust function
416 Maximum thrust

What is claimed is:

1-9. (canceled)

10. A power control unit for automatically controlling a drive of an aircraft which is in a normal operating state, the power control unit comprising:
a control device; and
an input device which comprises at least one adaptive power marker, wherein,
the aircraft is configured to fly in ambient air via a dynamic lift for overcoming a service weight, the aircraft comprising:
a first engine which is configured to generate a first drive thrust which comprises a first idle thrust and a first maximum thrust; and
at least one second engine which is configured to generate a second drive thrust which comprises a second idle thrust and a second maximum thrust, wherein,
each of the first engine, via the first drive thrust, and the at least one second engine, via the second drive thrust, can be accelerated relative to the ambient air,
a specified power can be input by an operator via the input device,
the control device is configured so that, in the normal operating state, the first drive thrust and the second drive thrust are controlled relative to one another depending on the specified power at an increasing specified power so that the first engine is first controlled at an increasing first drive thrust and, only after a first upper limit thrust of the first engine has been reached, the second drive thrust is also additionally controlled so as to increase, until a common drive thrust corresponding to the specified power is reached, and
each of the at least one adaptive power marker is configured to output at least one of
an optical feedback and a haptic feedback on at least one of
an available common drive thrust, an available relevant maximum thrust of at least one of the first engine and the second engine, and
if a malfunction exists.

11. The power control unit as recited in claim 10, wherein the control device is further configured so that, in the normal operating state, the first drive thrust and the second drive thrust are controlled relative to one another depending on the specified power at a decreasing specified power so that, the second engine is first controlled at a decreasing second drive thrust and, only after a second lower limit thrust of the second engine has been reached, the first drive thrust is also additionally controlled so as to decrease, until the common drive thrust corresponding to the specified power is reached.

12. The power control unit as recited in claim 11, wherein at least one of,
the first upper limit thrust corresponds to the first maximum thrust or an upper limit thrust of the first engine that is safe for a relevant operating state, and
the second lower limit thrust corresponds to the second idle thrust.

13. The power control unit as recited in claim 10, further comprising:
a malfunction sensor which is configured to identify the malfunction, wherein,
when the malfunction sensor identifies that the malfunction has occurred on the first engine, the control device is further configured to switch into a malfunction operating state where the second drive thrust of the at least one second drive engine as a non-malfunctioning engine is controlled until the common drive thrust corresponding to the specified power is reached or until there is an available drive thrust corresponding to the second maximum thrust, or
when the malfunction sensor identifies that the malfunction has occurred on the at least one second engine, the control device is further configured to switch into a malfunction operating state where the first drive thrust of the first drive engine as a non-malfunctioning engine is controlled until the common drive thrust corresponding to the specified power is reached or until there is an available drive thrust corresponding to the first maximum thrust.

14. The power control unit as recited in claim 10, further comprising:
a display device which is assigned to the input device, the display device being configured to display at least one of information relating to a relevant operating state, information relating to an available maximum drive thrust, and information regarding an identified malfunction.

15. The power control unit as recited in claim 10, wherein the input device is a thrust lever unit.

16. The power control unit as recited in claim 15, wherein,
the thrust lever unit comprises a thrust lever and a brake device which is configured to adaptively hamper a movement of the thrust lever.

17. The power control unit as recited in claim 16, wherein the at least one adaptive power marker is produced via the brake device.

18. A drive system comprising:
the power control unit as recited in claim 10;
the first engine; and
the at least one second engine.

19. The drive system as recited in claim 18, wherein,
the first maximum thrust is at most 45% to 90% of the second maximum thrust, or
the second maximum thrust is at most 45% to 90% of the first maximum thrust.

20. An aircraft comprising:
the drive system as recited in claim 19.

21. An aircraft comprising:
the power control unit as recited in claim 10.
